(19) United States
(12) Patent Application Publication
(10) Pub. No.: US 2011/0192799 A1
(43) Pub. Date: Aug. 11, 2011

(54) Sorbent Compositions

(76) Inventor: Jeffrey A. Brelsford, Quakertown, PA (US)

(21) Appl. No.: 13/123,513

(22) PCT Filed: Oct. 9, 2009
(86) PCT No.: PCT/US09/60174

§ 371 Date: Apr. 8, 2011

Related U.S. Application Data
(60) Provisional application No. 61/104,605, filed on Oct. 10, 2008.

(51) Int. Cl. B01D 15/00; B01J 20/28; B01J 20/26; C09K 21/06

(52) U.S. Cl. 210/660; 502/400; 502/402; 252/602

(57) ABSTRACT

Mats for absorbing one or more fluids are disclosed. The mats comprise fiberglass and optionally, one or more additional fibers, such as low melt thermoplastic binders. Multilayer are disclosed featuring glass fiber sandwiched between one or more nonwoven fabrics on one or more faces. Methods for manufacturing and using the mats to absorb/adsorb one or more fluids are disclosed. A medium comprising fiberglass and one or more sources of additional fiber is also disclosed, as are kits for absorbing fluids using the mats or the medium.

### CROSS REFERENCE TO RELATED APPLICATIONS

This application claims the benefit of U.S. Provisional Application No. 61/104,605, filed Oct. 10, 2008, the entirety of which is incorporated herein by reference.

### BACKGROUND

1. Field of the Invention

This relates to sorbent compositions generally, and, more particularly to compositions comprising glass fibers in mats or pads useful for taking-up fluids, for example, industrial waste, spills, seepage, leaks, and the like.

2. Description of Related Art

Absorbent mats and pads are known in the art for use in retaining or absorbing fluids from for example, spills, leakage, seepage and the like. Such absorbent mats or pads can be used for absorption of chemical spills or leaks, waste products, hazardous materials, medical or biological fluids, and the like from industrial operations, manufacturing facilities, hospitals or other medical facilities, maintenance yards, shipping terminals, storage lots, as well as other sources of such fluids. The use of such mats or pads is also known for absorbing oil or petroleum products that are unintentionally released or spilled onto natural or man-made waterways where they pose risks to the natural environment, water sources, wildlife, human populations, and equipment and industry.

Certain ideas for sorbent products for handling spills have been previously disclosed. For example, U.S. Pat. No. 5,078,890 purports to disclose use of felts comprising bindered mineral fibers for absorbing petroleum products from bodies of water. The felts include glass wool or rock wool maintained in a highly-compressed form before use. U.S. Pat. No. 5,215,407, by the present inventor, discloses the use of bundles of shredded blown glass fibers (i.e. unbindered fibers) for absorbing spills of materials such as oil on water and other surfaces. U.S. Pat. No. 6,180,233 purports to disclose a “super-sorbent” material comprising bindered or unbindered glass fibers and hydrophilic particles.

The sorbent mats and pads that have been used commercially appear to be limited to those that are made of synthetic polymers, and those made of certain absorbent natural substrates such as corn cobs. There remains a need for new and improved absorbent compositions.

### SUMMARY

Novel sorbent mats are disclosed for addressing fluid spills in a variety of industrial, consumer, research, and other settings. Preferably, the mats comprise glass fiber bonded with low melt thermoplastic binder fibers, and optionally a mixture of other natural and synthetic fibers.

In one aspect of the invention, sorbent mats having a depth (or thickness), a length, a width, and first and second faces and comprising a medium having glass fiber and, optionally, one or more additional fibers are provided. The mat absorbs an amount of the fluid when the mat is brought into contact therewith. Preferably the amount of fluid that can be absorbed or adsorbed by the mats is substantial (e.g. 1-2, 5-10, 10-15, and 15-20 or more times the weight of the mat) and preferably the mats perform satisfactorily and in accordance with standard testing procedures for testing the performance of adsorbents, for example that described in ASTM F-726-06.

The mats preferably comprise a medium that is contains a ratio of glass fiber to additional sources of fiber that ranges from 5:95 to 1:0 on a weight basis. The medium from which the mats are made generally comprises nonwoven fibers, as are the mats themselves. Typically both are completely nonwoven. The medium from which the mats are made preferably comprises glass fiber and a mixture of synthetic, and/or natural fibers, including low melt thermoplastic fiber. The medium in certain embodiments comprises at least 10-30% low melt thermoplastic fiber. In other embodiments, the medium can further comprise 50-60% or more natural fiber, such as cellulosic fibers.

In another of its several aspects, methods of removing at least one fluid from a location are provided. The methods generally comprise the steps of
a) causing at least one mat comprising at least 5% glass fiber and optionally, one or more additional fibers to come into contact with the fluid, said mat having a depth, a length, a width and first and second faces;
b) allowing sufficient time for the at least one mat to absorb the fluid; and
c) removing the at least one mat and the fluid absorbed therein from the location.

The methods frequently employ a mat that further comprises a covering layer covering one or both faces; said covering layer comprising one or more nonglass fibers—whether natural or synthetic.

In another of its aspects, the invention provides a sorbent medium comprising at least 5% glass fiber and one or more other sources of fibers. Preferably, the ratio of glass fiber to other sources of fiber ranges from 5:95 to 98:2, or even 100:0, on a dry weight basis. In certain presently preferred embodiments, the sorbent medium comprises a low melt thermoplastic fiber.

In yet another of its several aspects, the invention provides kits useful for absorbing a fluid from a location. The kits generally comprise:

a) a medium for absorbing a fluid said medium comprising at least 5% fiberglass and one or more other sources of fibers; or

b) a mat for absorbing a fluid from a location at which that fluid is not desired, the mat having a length, a width, and first and second faces and comprising a medium comprising glass fiber and, optionally, one or more additional fibers; wherein the mat absorbs an amount of the fluid when the mat is brought into contact therewith; and

c) instructions for use thereof; and optionally,

d) one or more pieces of safety equipment to be used in conjunction with the medium or mat including safety goggles, safety gloves, a safety masks or air filter, self-contained breathing apparatus, one or more articles of clothing or covering or skin protective gear to be worn when absorbing a fluid, safety bathers, booms or absorbent socks for containing or absorbing fluid spills, decontamination supplies; or disposal devices or bags; emergency supplies including communication gear.

These and other aspects of the invention will be further described by reference to the figures and the detailed description below.

### BRIEF DESCRIPTION OF THE DRAWINGS

FIG. 1: Process flow for representative air lay process for making nonwoven mats.

FIG. 2: Depicts an alternate process for making the nonwoven mats.

FIG. 3 Representative process for manufacturing a multilayered mat including a covering layer for one or both faces.

### DETAILED DESCRIPTION

### Definitions

The following abbreviations may be used herein:

The term “mat” as used herein is synonymous with “pad” when referring to a sorbent product. The skilled artisan will appreciate that mats or pads can be provided in predetermined sizes of length and width, or may be provided as rolls of material of a predetermined width which can be used as provided or can be cut to any needed length by the user.

As used herein the terms “sorbent” “absorbent” “adsorbent” “absorb” “adsorb” “adsorbing” and “absorbing” are used in a general sense and encompass any process by which a fluid can be accumulated into, on, or by a medium or substrate.

The term “fiber” as used herein refers to any fibrous or filamentous material, whether natural or synthetic, in the form of filaments or discreet elongate pieces having an average length substantially greater than the nominal cross-sectional width or diameter of the piece. Natural sources of fiber include sources of plant fibers from any part or portion of a plant. Plant fibers are generally cellulosic materials including, for example, seed fiber (such as cotton or kopok), bast fibers (such as fibers from banana, flax, jute, kenaf, industrial hemp, ramie, rattan, soybean, and various vines), leaf fibers (such as from sisal or agave), stalk fibers (from a plant stalk, stem, or trunk, such as from various grasses and crops such wheat, rice, barley, as well as bamboo and wood fiber), fruit fiber (such as coir, from coconut, or related products), and other absorbent plant material such corn silk, corn cob, absorbent seed material, pina, and the like. Regenerated fibers such as rayon and acetate fibers may also be useful herein in certain embodiments. Animal fibers include various products made from hair including silk, wool, cashmere, angora, mohair, horse hair, and alpaca Animal products also include insect products such as silk or other material from insects at any stage, or their cocoons. Fibers can also be obtained from avian sources, such as feathers, down, and the like, e.g. feather fiber. Minerals can also provide a source of fibers, for example, various forms of asbestos, basalt, and various mineral wools. Also, ceramic fibers including glass fiber, quartz fiber, and fibers made from aluminum oxide, silicon carbide, boron carbide, and the like as well as combinations of one or more of the foregoing. As used herein, “glass fiber” generally encompasses mineral and/or ceramic fibers, although fiberglass is generally the presently preferred form of “glass fiber” for manufacture and use of the media and/or mats described herein. Metal fibers, such as aluminum fibers, steel fibers and other such fibers may also be useful with the disclosed mats or pads in some embodiments. Synthetic fibers useful herein may include any fiber that is made by man for example, acrylics, aramids, carbon fibers, microfibers, polyamides (e.g., nylon), olefins, polyesters (including PLA and related compounds), polyethylenes, and the like.

Synthetic fibers include thermoplastic fibers that are useful in certain embodiments disclosed herein. As used herein “low melt” fibers preferably have a melting temperature of less than about 250 C. In various embodiments, “low melt” fibers melt at less than 220 C, 200 C, 180 C, 160 C or even 150 C.

As used herein, the term “fluid” encompasses any composition that is at least partially fluid under the prevailing conditions, or under conditions that can be establish for absorbing that fluid. “Fluid” as used herein may also refer to a composition that while possessing substantially fluid characteristics, also comprises some nonfluid material, for example suspended solid particles, pieces, or the like. For purposes herein, a gel may be a fluid in certain embodiments, or a fluid may be subject to gelling, or even solidifying under certain conditions.

All percentages expressed herein are by weight of the composition on a dry matter basis unless specifically stated otherwise. The skilled artisan will appreciate that the term “dry matter basis” means that an component's concentration or percentage in a composition is measured in the absence of free water, or determined on the basis of the weight of the composition after any the weight of any free moisture in the composition has been subtracted. Dry weight measurement may be particularly of use in determining percentages of natural fibers from plant materials.

As used throughout, ranges herein are stated in shorthand, so as to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, and so on.

As used herein and in the appended claims, the singular form of a word includes the plural, and vice versa, unless the context clearly dictates otherwise. Thus, the references “a”, “an”, and “the” are generally inclusive of the plurals of the respective terms. For example, reference to “a pad”, “a medium”, or “a fluid” includes a plurality of such “pads”, “mediums”, or “fluids.” Reference herein, for example to “a treatment” includes a plurality of such treatments, whereas reference to “pieces” includes a single piece. Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Where used herein the term “examples,” particularly when followed by a listing of terms is merely exemplary and illustrative, and should not be deemed to be exclusive or comprehensive.

The methods and compositions and other advances disclosed herein are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

Any patents, patent applications, publications, technical and/or scholarly articles, and other references cited or referred to herein are in their entirety incorporated herein by reference to the extent allowed by applicable law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved. Full citations for publications not cited fully within the specification are set forth at the end of the specification.

### DETAILS

This disclosure describes sorbent mats and pads for absorbing a fluid from a location at which that fluid is not desired, for example spills, leaks, seepage, overfill, and the like. Also described herein are the media from which the mats are made, and methods for use of such mats, or the media. Kits comprising mats and/or media are also described. The mats have a length, a width, a depth (i.e. thickness), and first and second faces. The mats comprise an absorbent medium comprising at least 5%, 10%, or 15% glass fiber in various embodiments, and optionally, one or more additional sources of fibers. The additional fibers can comprise low melt thermoplastic binder fibers and other synthetic and/or natural fibers. The mats absorb an amount of the fluid when the mat is brought into contact therewith.

Thus, in a first of its several aspects, disclosed are mats or pads for absorbing a fluid from a location at which that fluid is not desired. The mats have a depth (or thickness), as well as a length, a width, and first and second faces. The mats contain a medium which comprises at least 5%, 10%, or 15% glass fiber, in various embodiments. Optionally, one or more additional fibers from any source, including natural or synthetic are present in the medium. The mats absorb an amount of the fluid when brought into contact with the fluid. The amount of fluid absorbed is a function of the dimensions of the mat (i.e. the amount of the medium present), as well as the properties of the medium. It may also be a function of the physicochemical properties of the fluid.

The mats optionally comprise one or more other types of fibers, in amounts up to 85% of the composition. The additional fiber can comprise one or more natural or synthetic fibers, or a combination of natural or synthetic fibers. In various embodiments, the compositions comprise ratios of glass fiber to additional fiber of 100:0 to about 5:95%, but more generally from about 98:2 to about 10:90. Presently preferred ratios include 100:0, 90:10, 80:20, 70:30, 65:35, 60:40, and 50:50 fiberglass to additional fiber. Also preferred are compositions featuring 40:60, 30:70, 25:75, 20:80, and 15:85 glass fiber to additional fiber. It is preferred that the mats feature at least 10-15% fiberglass in certain embodiments. In yet other embodiments, the glass fiber content is 5-10%.

The inventor has surprisingly found that certain glass fibers, and certain forms of fiberglass cannot conveniently be formed into a mat or a pad acceptable for use in absorbing spills. Further, it has been determined that one cause for the lack of acceptability of such pads or mats is the length of the, e.g., fiberglass fibers. The inventor has discovered that fiberglass which is preferred for it absorptive properties either cannot form such pads, or forms pads which do not retain their structural integrity in use, due to a relatively short fiber length. Thus, presently preferred fibers to be used in the mats or pads in addition to the glass fiber are fibers with sufficient length and or other properties to assist in maintaining the composition in preferred configurations such as mats or pads.

To resolve the problems associated with sorbent properties, mat integrity, and glass fiber length, the inventor has found that, surprisingly, two solutions are available.

As part of a first solution, glass fiber (e.g. fiberglass) with the desired sorbent properties can be manufactured with a fiber length sufficient to form mats or pads capable of performing the intended use, while retaining satisfactory structural integrity throughout the duration of use. Such fibers are useful in certain embodiments herein. Such fibers are available commercially, e.g. as THERMACUBE® (Owens Corning), or INSUL-SAFE III® (CertainTeed Corporation) fiberglass, or from Ottawa Fibers (Canada) as fiberglass insulation batting.

As part of a second solution, fiberglass having the desired absorptive properties can be combined with that allow the formation of mats or pads which are both capable of performing the intended use and which retain sufficient structural integrity throughout the duration of use. Examples of this include various synthetic and natural fibers as described above. In one presently preferred embodiment, the inventor has surprisingly discovered that the in elusion of certain synthetic fibers, such as thermoplastic fibers, produces a mat with excellent properties in terms of sorbency and strength. Particularly preferred thermoplastic fibers are low melt thermoplastic bonding fibers. Examples of low melt thermoplastic bonding (or binding) fibers include polyester bi-component fibers and/or polypropylene melt-blown fibers, commercial products of which are available from Wellman (NY, USA) or Delstar (DE, USA), respectively.

In one present preferred embodiment, the mats are made from a medium that contains about 10% fiberglass, about 10% low melt thermoplastic fiber, and about 60% natural fiber or cellulosic fiber. In another such embodiment, the medium contains about 80% fiberglass and about 20% low melt thermoplastic fibers.

The additional fibers to be combined with the absorptive fiberglass may themselves have desirable absorptive properties, or they may merely provide sufficient structural integrity to allow the fiberglass to be enmeshed in a pad suitable for the intended use.

Compounds or components that provide resistance to compression may also be optionally used in the mats or pads disclosed. Such compounds can be useful in preventing disintegration of the mats under conditions of use, and also can aid in preventing the absorbed fluid from being “squeezed out” of the mat during recover of the used mat.

In one embodiment, the mat further comprises a covering layer, or cover, covering one or both faces thereof, or covering the entire mat, or substantially the entire mat. Preferably, the covering layer comprises less than 20% fiberglass, more preferably it contains less than 15% fiberglass. Some covers have no fiberglass present, or, are substantially comprised of polypropylene. Presently, the inventor has found it useful in certain embodiments to have a cover made primarily or entirely of polypropylene microfibers, such as polypropylene melt-blown microfibers. In other embodiments the cover is entirely or substantially made of polypropylene spunbond.

In some embodiments having such covers, the mat comprises one or more means for retaining the covering on the mat, such as sonic welding, thermal attachments, quilting or the like, or the mat structure involves the use of one or more adhesive compounds or adhesive devices to retain the covering layer. In other embodiments, the cover is retained in place through friction between the underlying mat and the cover. In yet other embodiments, the covering layer is substantially integral with the mat itself. In such embodiments, the covering layer is not generally readily separated from the mat proper, although it may have been added in a manufacturing step that is subsequent to the formation of the mat proper.

The fluid is generally a waste product, a hazardous material, a biological waste, or an industrial fluid, or the like, although it can be any fluid. It is not required that the fluid be undesirable, rather in some embodiments, a useful or valuable fluid is spilled which needs to be recovered. The mats can be used to absorb the fluid and then the fluid can be recovered therefrom using any of a variety of physical or chemical methods, depending on the fluid. The skilled artisan will know how to maximize recovery of a useful fluid in such a case. Typically, however, the fluid results from spillage, leakage, or seepage, or other undesired or improper release or escape from one or more sources, whether accidental or intentional.

In one embodiment, the mats only absorb, or substantially only absorb fluids that are not miscible with aqueous solvents. Such “oil-only” mats are frequently used where a fluid is spilled or dumped onto a body of water, such as in a lake, lagoon, reservoir, river, pond, ocean, sea, bay, port, marina, or the like. For such uses, it is of course desirable that the mats absorb only the fluid and will not also absorb water, thereby decreasing their utility or capacity for absorbing the spilled fluid. For such embodiments, it is preferred that the fiberglass and/or other fiber is treated to enhance its hydrophobicity. The skilled artisan will be familiar with method for treating fibers to enhance their hydrophobicity. In some embodiments of “oil-only” mats, one or more of the additional fibers are either hydrophobic (e.g. polypropylene), or the additional fibers are treated to enhance their hydrophobicity. The skilled artisan will appreciate the same or different method of treatment may be used on one or more of the additional sources of fiber, as is used on the fiberglass. In alternative embodiments, fibers with the desired properties may be selected initially. In yet other embodiments the medium from which the mat is made may be treated as whole to alter, increase, or enhance to sorbent properties, for example, its relative hydrophobicity. The treatment will of course depend on the properties of the fibers being used.

In one embodiment of the mats, one or more of the fibers, or the medium may be treated with silicone or similar treatment to increase the hydrophobicity. Fiberglass with such treatments is available from commercial sources such as Ottawa Fiber (Canada).

The mats or pads are adapted for use in any of a variety of locations including, for example, a natural or man-made body of water, a manufacturing plant or other industrial facility, research facilities, laboratories, hospitals, medical or other health care settings, garages or maintenance facilities, fueling stations, or military installation, pipelines, off-shore or deep-sea platforms, power plants, nuclear facilities, or the like. Further the mats can be placed in or on a liquid, such as on the surface of a body of water having a spill, or on the earth, floor or other surface, whether vertical, horizontal, or otherwise oriented. Where useful, the mats can feature one or more means or devices for temporarily securing the mats in the desired location, e.g. anchoring devices, or contact adhesive, e.g. for placement on surfaces that are not horizontal, or for securing in place against movement caused by natural or man-made forces (winds, currents, waves, or the like). The mats or the media from which they are made may be used to clean-up any spills, drips, sprays, leaks and the like, for example, from catastrophic spills (e.g. tank ruptures, accidents, punctures, failures, etc.), slow leaks, e.g. under pumps or discharge devices, from valves, from pin-holes, or resulting from scheduled or unscheduled maintenance or repairs, or the like.

For certain applications, it is useful for the mats to have buoyant properties. For example, in some cases, preferably the mats are buoyant, particularly on an aqueous solvent. In many cases, fluids must be removed or absorbed from a water source, whether fresh water or salt water, and for such purposes it is useful that the mats float, or at least do not sink. In one presently preferred embodiment, the mats are at least partially buoyant. In other embodiments the mats float at the surface of a aqueous liquid in which they are immersed or placed, for example, water or seawater. The mats may also be sufficiently buoyant to float on a fluid less dense than water, for example on oil or a fluid petroleum product. The mats, in certain embodiments, may further comprise one or more optional compounds or components that improve buoyancy, to allow the composition to float, for example when used to clean up a spill on the surface of, for example, a body of water, whether natural or man-made. In one embodiment, the mat retains its buoyancy for at least 6 hours under conditions of use, i.e. it does not sink after at least 6 hours of use. Preferably the disclosed compositions remain buoyant on water or on salt water, such as seawater, for at least 24 hours. In some embodiments, the compositions remain buoyant for at least 12 hours. Still other embodiments feature compositions that provide at 8, 6, or 4 hours of buoyancy.

In some embodiments the additional fiber helps to retain integrity of the mat during the time in which it is in use and is removed, relative to a mat comprising no additional fiber. Preferably, the mat substantially retains its integrity for at least 4 hours. In some embodiments the mats retain their integrity for 6-8 hours, 8-12 hours, or even 12-24 hours. Preferably there is no loss in the integrity of the mat as determined by the ability of the mat to be recovered when it is “fully loaded,” i.e. when it has absorbed about 90-100% of the maximum capacity for a given fluid.

With respect to sorbency, it is presently preferred that the mats have the ability to absorb at least 1-10 times the weight of the mat itself. More preferably, the mats will have sufficient sorbent ability to absorb 10-15 times or more their own weight. In certain embodiments, the mats can absorb 15.5, 16, 16.5, 17, or 17.5 times their own weight, or more. In yet other embodiments, more sorbent mats can absorb 18-20 times their own dry weight, or more. Preferably, the sorbent ability is measured by a standardized test for performance. Presently preferred tests are provided in ASTM F716-07 and ASTM F-726-06 entitled “Standard Test Methods for Sorbent Performance of Absorbents” and “Standard Test Method for Sorbent Performance of Adsorbents,” respectively. Those standards are used as a basis for comparison of absorbents/adsorbents in a consistent manner. ASTM F716-07 is used to test and compare the performance of absorbent materials used to remove oils and other compatible fluids from water.

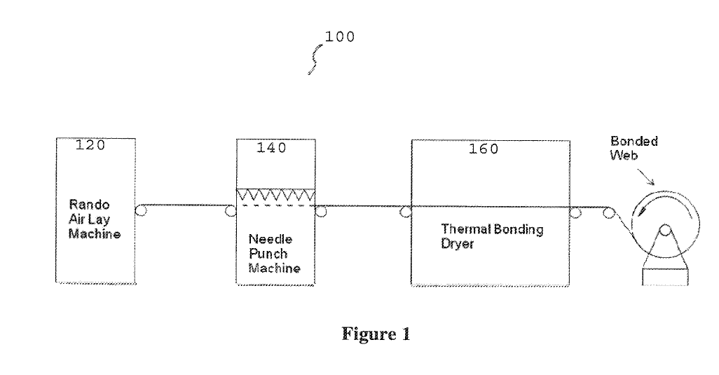

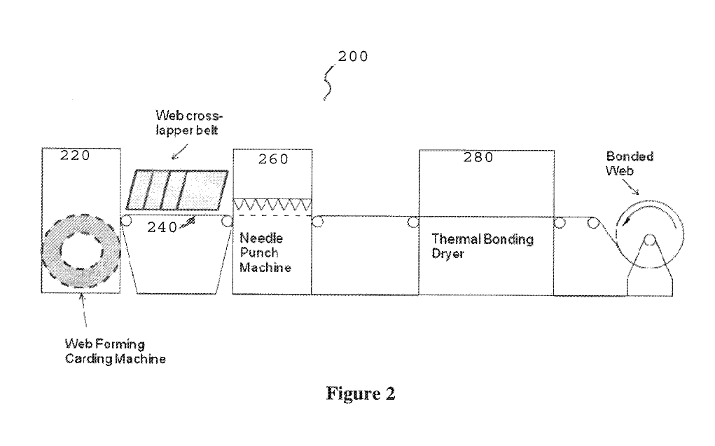

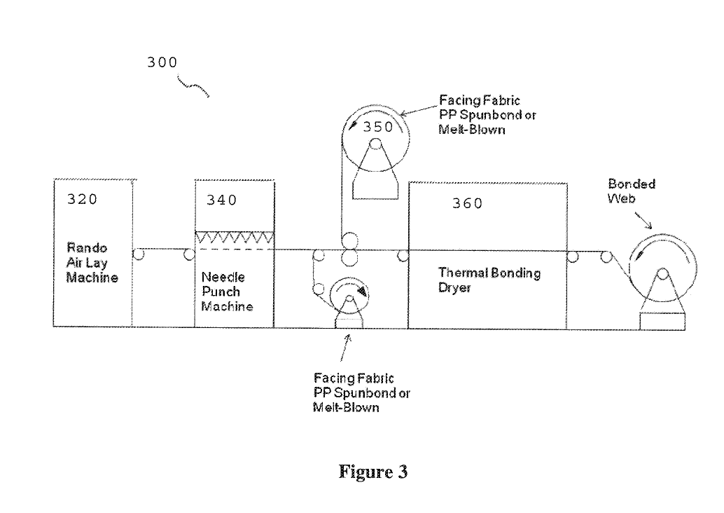

Mats consistent with those described herein can be made by standard methods known to skilled artisans. One representative process of making a mat in accordance with this disclosure is shown in FIG. 1. Such a process for making a mat compatible with the teachings herein is also described in U.S. Pat. No. 5,886,306. The mat can also be made using glass fiber and low melt thermoplastic binder by garneting, cross lapping and needling process as shown in FIG. 2. The mat can be further laminated with facing absorbent fibers such as polypropylene melt-blown micro fibers and spunbond nonwovens by ultrasonic or thermal point bonding process as shown in FIG. 3.

With further reference to FIG. 1, a preferred production method 100 for producing mats without facing fabric is shown. A medium comprising the desired fiber blend is fed to a Rando air lay machine 120 to make unbonded nonwoven web structure (not shown). The unbonded mat is processed through the needling machine 140 to provide further strength. The unbonded web is introduced into thermal bonding oven 160 where low melt binder can be added with the fibers act as bonding agent. The resultant roll of mat can be used or sold as is, or cut to desired pad sizes.

With further reference to FIG. 2, an alternate air lay process 200 is depicted. Medium comprising the fiber blend is converted into nonwoven web by the Garnetting machine 220. The unbonded web is layered into multiple layers by the cross-lapping belt 240 to obtain the final weight of the desired web. The unbonded mat is then processed through the needling machine 260 to provide further strength. The resultant unbonded web is then introduced into the thermal bonding oven 280 where low melt binder fibers act as bonding agent. The completed roll can be sold or used as is, or cut/slit to desired pad sizes. The web formed by the air lay process 200 generally has better strength than that formed the Rando air lay type web production 100. However, the web produced by air lay process 200 will be less uniform in weight in both machine and cross-machine directions. Also, glass fibers may break easily during Garnetting process 220.

With further reference to FIG. 3, another method 300 is shown. The production method 300 is similar to production method 100 in FIG. 1. The process 300 of web forming includes the additional optional step of providing a covering. A medium comprising the desired fiber blend is fed to a Rando air lay machine 320 to make unbonded nonwoven web structure (not shown). The unbonded mat is processed through the needling machine 340 to provide further strength. Facing fabrics (e.g. polypropylene melt-blown or spunbond) 350 are introduced before web enters into the thermal bonding oven 360. This results in a sandwich wherein the formed web is between two facing fabrics. The faced product is further bonded, e.g. to weld the cover to the mat, for example, by Ultrasonic bonding (not shown) in diamond pattern.

In another of its several aspects, the invention disclosed herein provides methods of removing at least one fluid from a location at which, e.g., it is not desired. The removal is typically accomplished by absorbing the fluid in/on a mat or pad and subsequently removing the mat or pad with the fluid.

The methods generally comprise the steps of:

a) causing at least one mat comprising, in various embodiments, at least 5%, 10%, or 15% glass fiber, and optionally, one or more additional sources fibers to come into contact with the fluid, said mat having a length, a width, a thickness, and first and second faces;

b) allowing sufficient time for the at least one mat to absorb at least a portion of the fluid; and

c) removing the at least one mat and the fluid absorbed therein from the location.

As above with the described mats and pads, the first and/or second faces are optionally covered with a covering layer that preferably contains no glass fiber, or in other embodiments less than about 15-20% fiberglass.

In various embodiments, the mats useful in the methods herein comprise up to 100% glass fiber, such as fiberglass wool.

In one embodiment, one or more of the glass fiber or an additional fiber is subjected to one or methods of treatment to enhance the hydrophobicity thereof, as with the mats or pads described above. For example, the fibers may be treated with a chemical or physical process, such as with silicon. In other embodiments, at least one of the additional fibers has desired properties in terms of hydrophobicity, or alternatively is also treated to enhance its hydrophobicity. The fibers' ability to reject (not absorb) aqueous material, such as water, can this be determined according to the intended use. Methods of treating glass or glass fibers to increase their hydrophobicity, relative to untreated glass fibers, are known in the art and will be apparent to a skilled chemist. Methods of increasing the hydrophobicity of other fibers, including for example natural and cellulosic fibers are also known in the art.

In one embodiment, fluid is dispersed or spilled on a body of water and the mat is sufficiently buoyant to float on the body of water at least until the removing step. In such embodiments, generally the fluid is not substantially miscible with an aqueous solvent, and is preferably less dense than the water on which it is dispersed, i.e. the fluid itself is floating on the water. Preferably for such embodiments, the mats selected will preferentially or exclusively absorb only hydrophobic/oil-based material.

In one embodiment of the methods, the mats used therein further comprise a covering layer covering one or both faces of the mat, and/or covering the entire mat. The covering layer preferably comprises less than 15-20% fiberglass. Presently preferred covering layers include polypropylene, e.g. in the form of melt-blown microfibers, or polypropylene spunbond.

In certain embodiments, presently preferred mats for use in the methods are made from medium that comprises 10% fiberglass, about 10% low melt thermoplastic fiber, and about 60% natural fiber or cellulosic fiber. In another such embodiment, the medium contains about 80% fiberglass and about 20% low melt thermoplastic fibers.

Also disclosed herein is a medium for absorbing a fluid said medium comprising at least 5%, 10%, or 15% glass fiber in various embodiments, and one or more other sources of fiber. Preferably the ratio of glass fiber to other sources of fiber in the medium ranges from 5:95 to 98:2 on a weight basis. In certain preferred embodiment, the medium contains 5%, 10%, 15%, 20%, 25%, 30%, or more glass fiber. One presently preferred medium generally has at least 5-10% fiberglass. In various embodiments, the one or more other sources of fiber include natural or synthetic fibers, as defined herein.

In one embodiment, the medium comprises a low melt thermoplastic fiber, such as a low melt thermoplastic bonding fiber, as described herein above for the mats. The medium in various embodiments comprises 5-50% low melt thermoplastic fiber. In certain embodiments, the medium comprises between about 10% and about 30% low-melt thermoplastic fiber. In specific embodiments, the medium comprises 10% fiberglass, about 10% low melt thermoplastic fiber, and about 60% natural fiber or cellulosic fiber; or the medium contains about 80% fiberglass and about 20% low melt thermoplastic fibers.

In one embodiment, the medium is general purpose in terms of its sorbent properties, and can absorb/adsorb both water/aqueous fluids as well as nonaqueous fluids and even fluids that are immiscible with aqueous solvents. In other embodiments, the medium absorbs only fluids that are not miscible with an aqueous solvent. In such embodiments, it is preferred that the fiberglass be treated to enhance its hydrophobicity. Preferably one or more of the other sources of fiber are either hydrophobic, or are also treated so as to enhance their hydrophobicity. Thus, as described above for the mats, the sorbent properties of the medium can be adapted, by the choice of fibers, and the relative hydrophobicity or hydrophilicity thereof which can be modified by chemical or physical treatment of the fibers before or after manufacture. For example, the medium, like the mats above, can be treated or selected such that it absorbs only fluids that are not miscible (i.e. substantially not miscible) with an aqueous solvent, for example by treating the fiberglass and/or additional fibers to enhance their hydrophobicity. The skilled artisan will also appreciate the medium and/or mats made therefrom can be designed to preferentially absorb aqueous fluids from an oil base.

In another embodiment, the ratio of glass fiber to other sources of fiber is a function of the fiber length of the glass fiber and the other sources of fiber, such that the medium is capable of being formed into a mat or pad having sufficient integrity to absorb a fluid and be removed together with said absorbed fluid. In such embodiments, the skilled artisan can empirically determine a useful ratio of e.g., fiberglass to other source of fiber. In another embodiment, the ratio of fiberglass to other sources of fiber is optimized by either minimizing the cost of production or maximizing the amount of fiberglass in the medium, provided the optimized medium is capable of being formed into a mat or pad having sufficient integrity to absorb a fluid and be removed together with said absorbed fluid. Again, the skilled artisan will readily be able to empirically determine useful ratios of fiberglass to other sources of fiber. Computer optimization may also be used for optimizing costs of production given a useful range of the ratio of fiberglass to other source of fiber, and given the relative or actual costs of each source of fiber and the fiberglass.

Also disclosed herein are kits for absorbing a fluid from a location comprising a medium or a mat for absorbing the fluid as disclosed above, and instructions for their use, and optionally, one or more pieces of safety equipment.

Kits useful for absorbing a fluid from a location generally comprise:
a) a medium for absorbing a fluid said medium comprising at least 15% fiberglass and one or more other sources of fibers; or
b) a mat for absorbing a fluid from a location at which that fluid is not desired, the mat having a length, a width, and first and second faces and comprising a medium comprising at least 5, 10 or 15% fiberglass (in various embodiments) and, optionally, one or more additional fibers; wherein the mat absorbs an amount of the fluid when the mat is brought into contact therewith; and
c) instructions for use thereof; and optionally,
d) one or more pieces of safety equipment to be used in conjunction with the medium or mat including safety goggles, safety gloves, a safety masks or air filter, self-contained breathing apparatus, one or more articles of clothing or covering to be worn when absorbing a fluid, safety bathers, booms or absorbent socks for containing or absorbing fluid spills, decontamination supplies; or disposal devices or bags; emergency supplies including communication gear.

These and other aspects of the invention will be further illustrated by the following working examples which are included to augment, not limit the understanding and communication of the invention, as expressed in the appended claims.

### EXAMPLES

The invention can be further illustrated by the following example, although it will be understood that this example is included merely for purposes of illustration and is not intended to limit the scope of the invention unless otherwise specifically indicated.

### Example 1

A mat comprising fiberglass fibers of 1 to 3″ in length is manufactured with or without an outer covering layer of, for example, polypropylene or cotton. The mat is found to have excellent buoyancy properties and can float for up to 24 hours in fresh or salt water. The mat has sufficient integrity to be applied to a spill and removed without disintegrating and without losing substantial quantities of the absorbed fluid. The outer covering layer is found to be useful for safety and consumer acceptance to avoid contact with the fiberglass, and to help retain the integrity of the mat during shipping and use. It is also found that the covering layer can be quilted, sonically welded, or otherwise attached to the mat through thermal means, or with the use of adhesive.

### Example 2

A roll of absorptive pad is manufactured comprising about 50% fiberglass fibers of short length (less than about 1″ on average) and a natural fiber, such as cotton. It is found that both the fiberglass and the cotton can be readily treated to enhance their hydrophobicity to provide excellent “oil-only” absorptive properties wherein the mat can be used to absorb only fluids that are not miscible in aqueous solvent, even in the presence of excess water or aqueous solvent, for example a spill of oil or fuel on a body of water. It is found that the roll can be made to any required dimensions of width and depth (i.e. thickness), and of any length that is required or convenient. The pads can also be cut to predetermined sizes of any length and width. It is also found that additional covering is not required on the faces of the pad material due to the presence of the cotton.

### Example 3

A multi-layered absorbent pad is prepared. The pad comprises at least one layer comprising about 20% fiberglass and the remainder is comprised of one or more polymers or fibers for example, polypropylene, polyester, polyethylene, polyamide, acrylic, nylon, silk, wood fiber, cotton, hemp, or other cellulosic fibers. The multilayered absorbent pad is useful for absorbing inadvertent or accidental spills, as well as for routine use in preventing drips, seepage, leaks and the like. The multilayered pads can be provided individually, or in rolls that are pre-perforated, or which can be cut to any useful length by the user.

### Example 4

A mat comprising fiberglass fibers of 1 to 3″ in length is manufactured using 80% fiberglass and 20% low melt thermoplastic binder fiber with or without an outer covering layer of, for example, polypropylene or cotton in accordance with a process 100, 200, or 300. The covering layer, where used, can be quilted, sonically welded, or otherwise attached to the mat through thermal means, or with the use of adhesive. The mat is expected to have excellent buoyancy properties and can float for up to 24 hours in fresh or salt water. The mat is expected to have sufficient integrity to be applied to a spill and removed without disintegrating and without losing substantial quantities of the absorbed fluid. The outer covering layer is found to be useful for safety and consumer acceptance to prevent or minimize contact with the fiberglass, and to help retain the integrity of the mat during shipping and use. The mat absorbs 20× its own weight when tested by a standard method of testing sorbent performance, such as ASTM F-726-06 or ASTM F716-07.

### Example 5

A roll of absorptive pad is manufactured comprising about 10% fiberglass fibers of short length (less than about 1″ on average) with 15-20% binder fibers and 70% natural fiber, such as cotton. It is expected that both the fiberglass and the cotton can be readily treated to enhance their hydrophobicity to provide excellent “oil-only” absorptive properties wherein the mat can be used to absorb only fluids that are not miscible in aqueous solvent, even in the presence of excess water or aqueous solvent, for example a spill of oil or fuel on a body of water. The roll can be made to any required dimensions of width and depth (i.e. thickness), and of any length that is required or convenient. The pads can also be cut to predetermined sizes of any length and width. It is also expected that additional covering is not required on the faces of the pad material due to the presence of the cotton. The mat preferably absorbs 16.5× its dry weight, when tested by a standard method of testing sorbent performance, such as ASTM F-726-06 or ASTM F716-07.

### Example 6

A multi-layered absorbent pad is prepared. The pad comprises at least one layer comprising about 20% fiberglass and the remainder is comprised of one or more polymers or fibers for example, polypropylene, polyester, polyethylene, polyamide, acrylic, nylon, silk, wood fiber, cotton, hemp, or other cellulosic fibers. The multilayered absorbent pad is expected to be useful for absorbing inadvertent or accidental spills, as well as for routine use in preventing drips, seepage, leaks and the like. The multilayered pads can be provided individually, or in rolls that are pre-perforated, or which can be cut to any useful length by the user. The mat preferably absorbs 18× its dry weight, when tested by a standard method of testing sorbent performance, such as ASTM F-726-06 or ASTM F716-07.

In the specification, there have been disclosed typical preferred embodiments of the invention. Although specific terms are employed, they are used in a generic and descriptive sense only and not for purposes of limitation. The scope of the invention is set forth in the appended claims. Many modifications and variations of the disclosed invention are possible in light of the teachings herein. It is therefore to be understood that the invention may be practiced otherwise than as specifically described.

What is claimed is:

1. A sorbent mat having a depth, a length, a width, and first and second faces and comprising a medium comprising glass fiber and, optionally, one or more additional fibers; wherein the mat absorbs an amount of the fluid when the mat is brought into contact therewith.

2. The mat of claim 1 wherein the ratio of glass fiber to additional fiber ranges from 5:95 to 1:0 on a weight basis.

3. The mat of claim 1 which is nonwoven.

4. The mat of claim 1 wherein the medium comprises glass fiber and a mixture of synthetic, and natural fibers.

5. The mat of claim 1 wherein the medium comprises low melt thermoplastic fiber.

6. The mat of claim 1 wherein the medium comprises at least 20% low melt thermoplastic fiber.

7. The mat of claim 5 wherein the medium comprises at least 30% low melt thermoplastic fiber and about 60% cellulosic fiber.

8. The mat of claim 6 wherein the cellulosic fiber is treated with a fire retardant.

9. The mat of claim 2 wherein one or more of the additional fibers are hydrophobic, or one or more of the glass fiber or the additional fibers are treated to increase their hydrophobicity.

10. The mat of claim 7 which absorbs substantially only fluids that are not miscible with aqueous solvents.

11. The mat of claim 1 further comprising a covering layer substantially covering one or both faces of the mat, wherein said covering layer comprises one or more nonglass fibers.

12. The mat of claim 9 wherein the covering layer comprises fiber that is spunbond or melt-blown.

13. The mat of claim 10 wherein the covering layer comprises polypropylene or polypropylene microfiber.

14. The mat of claim 1 wherein the fluid is a waste product, a hazardous material, a biological waste, or an industrial fluid, or wherein the fluid results from spillage, leakage, or seepage, or other undesired release or escape from one or more sources.

15. A method of removing at least one fluid from a location comprising the steps of
a) causing at least one mat comprising at least 5% glass fiber and optionally, one or more additional fibers to come into contact with the fluid, said mat having a depth, a length, a width and first and second faces;
b) allowing sufficient time for the at least one mat to absorb the fluid; and
c) removing the at least one mat and the fluid absorbed therein from the location.

16. The method of claim 15 wherein the mat further comprises a covering layer covering one or both faces thereof; said covering layer comprising one or more nonglass fibers.

17. The method of claim 15 wherein the fluid is on a body of water and the mat is sufficiently buoyant to float on the body of water at least until the removing step.

18. The method of claim 15 wherein the fluid is not miscible with an aqueous solvent and at least one of the additional fibers is hydrophobic, or one or more of the glass fiber or the additional fibers are treated to increase its hydrophobicity.

19. A medium for absorbing a fluid said medium comprising at least 5% glass fiber and one or more other sources of fibers.

20. The medium of claim 19 wherein the ratio of glass fiber to other sources of fiber ranges from 5:95 to 95:5 on a weight basis.
